(19) United States
(12) Patent Application Publication
(10) Pub. No.: US 2025/0094573 A1
(43) Pub. Date: Mar. 20, 2025

(54) ANOMALY DETECTION BASED ON BEHAVIOR MODELING LEARNED FROM MONITORED COMPUTER ACTIVITIES

(71) Applicant: MASTERCARD TECHNOLOGIES CANADA ULC, Vancouver (CA)

(72) Inventors: James YANG, Vancouver (CA); Cynthia DIONISIO, Toronto (CA); Srikanth Nageshwar Rao SISTA, Richmond (CA); Jose RODRIGUES, North York (CA); Shalini SHANMUGASUNDARAM, Scarborough (CA)

(73) Assignee: MASTERCARD TECHNOLOGIES CANADA ULC, Vancouver (CA)

(21) Appl. No.: 18/469,314

(22) Filed: Sep. 18, 2023

(51) Int. Cl. G06F 21/55

(52) U.S. Cl. CPC G06F 21/554; G06F 21/552

(57) ABSTRACT

A system may receive, from a monitored system, behavior data that indicates one or more types of computer activities requested by a requester. The system may identify a behavior profile that was generated during a training phase to learn behaviors of the requester, the behavior profile including information that identifies one or more computer activities that were monitored during the training phase. The system may provide, during a detection phase, the behavior data to the behavior classifier to detect whether the behavior data is anomalous. The system may generate an anomaly classification based on the behavior data and the behavior profile. The anomaly classification indicates a predicted anomalousness of the behavior data with respect to the behavior profile and is used to determine whether a mitigative action is to be taken in response to the one or more types of activities requested by the requester.

### BACKGROUND

Computer devices and accounts may be compromised by malicious code that can result in loss of data, system function, accessibility to data or functions, and/or other harmful effects. For example, the malicious code may program a host device to perform computer activities that give rise to these or other harmful effects. A computer activity is a function executed by a computer device. For example, a computer activity may include file transactions, service access, application execution, hardware access, and/or other types of activities that can be executed by a computer system. In particular, a computer activity may include accessing, encrypting, deleting, modifying, or copying data. One example of malicious code is ransomware, in which malicious code programs a host device to perform one or more computer activities that makes data or computer functionality unavailable until a ransom is paid. In some instances, the data and/or functionality is restored upon payment of the ransom. In other instances, the data and/or functionality may be irretrievably lost.

Various systems have been developed to respond to these and other types of malicious attacks. For example, backup systems may generate and store backup copies of known-good data and other system information. In the event of a malicious attack, the compromised system can be restored to a previous known-good state using the backup copies. However, system restoration from these backup copies may take time, extending or causing system downtime. Furthermore, data generated after the latest backup copy was made may be irretrievably lost. Thus, what is needed is to prevent or mitigate against loss of data or function in real time. Because of the nature of some of these attacks, it may be difficult to detect attacks in real-time for meaningful prevention and mitigation. These and other issues may exist with defending against malicious attacks on computer systems.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment for detecting anomalies based on behavior modeling learned from monitored computer activities;

FIG. 2A illustrates an example of an embedded agent integrated with a device, which may be operated by a user, in a monitored system;

FIG. 2B illustrates an example of an embedded agent integrated with a network device in the monitored system;

FIG. 2C illustrates an example of an embedded agent integrated with a server device in the monitored system;

FIG. 3 illustrates an example of a method of generating behavior data based on a monitored computer activity, transmitting the behavior data for generating an anomaly classification, and determining a mitigation action (if any) for the computer activity based on the anomaly classification.

FIG. 4 illustrates an example of a method of training a behavior classifier by learning behavior profiles based on monitored computer activities;

FIG. 5 illustrates an example of a method of generating an anomaly classification of behavior data based on a previously learned behavior profile used by a behavior classifier;

FIG. 6 illustrates an example of a computer system that may implement the various features of FIGS. 1-5.

### DETAILED DESCRIPTION

The disclosure relates to methods and systems of detecting anomalous computer activities. Computer activities may be initiated by a requester, which may include a user, a device, a service, a group of users such as users that share the same role in an organization, and/or other entity that may initiate a computer activity. An anomalous computer activity is one that deviates from an expected computer activity of the requester. This deviation may indicate a malicious attack. For example, an anomalous computer activity may indicate a ransomware attack. While configured to detect malicious attacks, the system may detect anomalous computer activities that are not necessarily malicious in nature. For example, faults in the system such as bugs in code, device misconfiguration, and/or other system errors may cause some of the same harmful effects as malicious code. These system errors may be unrelated to malware, but may nevertheless be detected based on anomalous computer activities that result from the errors.

Detecting anomalous computer activities may be computationally difficult. For example, one requester may ordinarily have different levels and types of computer activities than another requester. As such, what is anomalous for one requester may be normal for another. Thus, it may be difficult for a computer system to discern whether a specific computer activity of a specific requester is anomalous and should be prevented or is normal and should be permitted. More specifically, anomaly classification may overfit activity data for one requester and underfit activity data for another requester. Another issue with anomaly classification is the real-time nature of malicious threats, or even system errors that result in harmful effects on a computer system.

A computer system may address these and other issues with detecting anomalous computer activities by training a behavior classifier to learn behavior profiles of requesters. The behavior classifier may generate an anomaly classification of computer activity based on the learned behavior profile, which may be learned specifically for the requester. An anomaly classification is a prediction of an extent to which the requested computer activity deviates from a learned normal behavior based on previously learned computer activities. In some instances, the behavior classifier may be retrained to learn new behavior and/or fine-tuned based on the performance of prior anomaly classifications.

A monitored system may generate behavior data that indicates computer activities at or requested from the monitored system. For example, the monitored system may include an embedded agent that monitors requests for computer activities. An embedded agent is a system component that is integrated with the monitored system in a way that enables the embedded agent to monitor computer activities requested from the monitored system. The embedded agent may be integrated with the monitored system without modifying a requesting process. For example, a requesting process may include an encryption application that requests access to a file to encrypt the file. The encryption application may not be required to transmit the request for monitoring. In this example, the embedded agent may be integrated with an operating system or other component responsible for controlling access to the file. In another example, the embedded agent may be integrated with a Virtual Private Network (VPN) application to monitor incoming and/or outgoing network traffic. In this way, it may be unnecessary to modify underlying requesting processes that are being monitored, improving monitoring efficiency.

The embedded agent may be programmed to execute as a background process to monitor requested computer activities. Once the embedded agent detects the computer activity, the embedded agent may collect context data associated with the computer activity. Context data may include a date or time of the computer activity (or request for the computer activity), a network address, a geolocation, and/or other context data associated with the computer activity. The embedded agent may generate behavior data includes an identification of the requester, an identification of the computer activity, the context data, and/or other information associated with the computer activity.

The embedded agent may then transmit the behavior data to the computer system for training the behavior classifier during a training phase or classifying the behavior data into an anomaly classification during a detection phase. The training phase may be triggered by the embedded agent or by the computer system. The training phase may be triggered when the a training phase condition is met, such as when the embedded agent is first integrated into a device of the monitored system, when a behavior profile of a requester is unavailable or should be updated, and/or at other times. The training phase may activate for a predefined duration of time, which may be configured by an operator of the monitored system or the computer system. During the training phase, the computer system may learn the computer activities of the requester. The training phase may include learning threshold values for the computer activities and/or the context data. For example, the threshold value for a computer activity may indicate maximum number of files that a requester tends to access in a given time period. The threshold value for the context data may indicate, for example, that the requester tends to access files from only certain number of IP addresses, certain geolocations, times of day, and/or other context data.

Each of the context data may be assigned with a respective weight. A weight is a quantitative value that is used to adjust a value for a corresponding context. For example, a first context may be deemed to be more predictive of normal behavior than a second context. To illustrate, the time of day in which a computer activity occurs may be more predictive of normal activity than an IP address from which the computer activity was requested (or vice versa). In this example, the time of day context may be weighted more heavily than the IP address context. It should be noted that the first context data may be equal-weighted with respect to second context data, and other numbers of context data and their respective weights may be learned. Each of the weights may be initially predefined and then re-learned as new behavior data is received. For example, one or more weights may be re-adjusted depending on the performance of the anomaly classifications.

During the detection phase, the computer system may execute the behavior classifier using information from the behavior data as an input. The behavior classifier may generate the anomaly classification of the behavior data based on the computer activity, context data, and/or other information from the behavior data. The behavior classifier may evaluate the behavior data against the learned behavior profile of the requester to generate an anomaly classification for the behavior data. For example, the behavior classifier may determine deviations of the computer activity and/or context in the behavior data from expected values in the behavior profile. The behavior classifier may generate vector values that represent the deviations. The behavior classifier may apply a corresponding weight to each quantified deviation, aggregate the weighted quantified deviations, and generate the anomaly classification based on the aggregate. The computer system may return the anomaly classification to the embedded agent. The embedded agent may identify a mitigation action based on the anomaly classification. For example, the embedded agent may evaluate the anomaly classification against one or more mitigation rules that specify mitigation action to take, if any, in response to a corresponding anomaly classification.

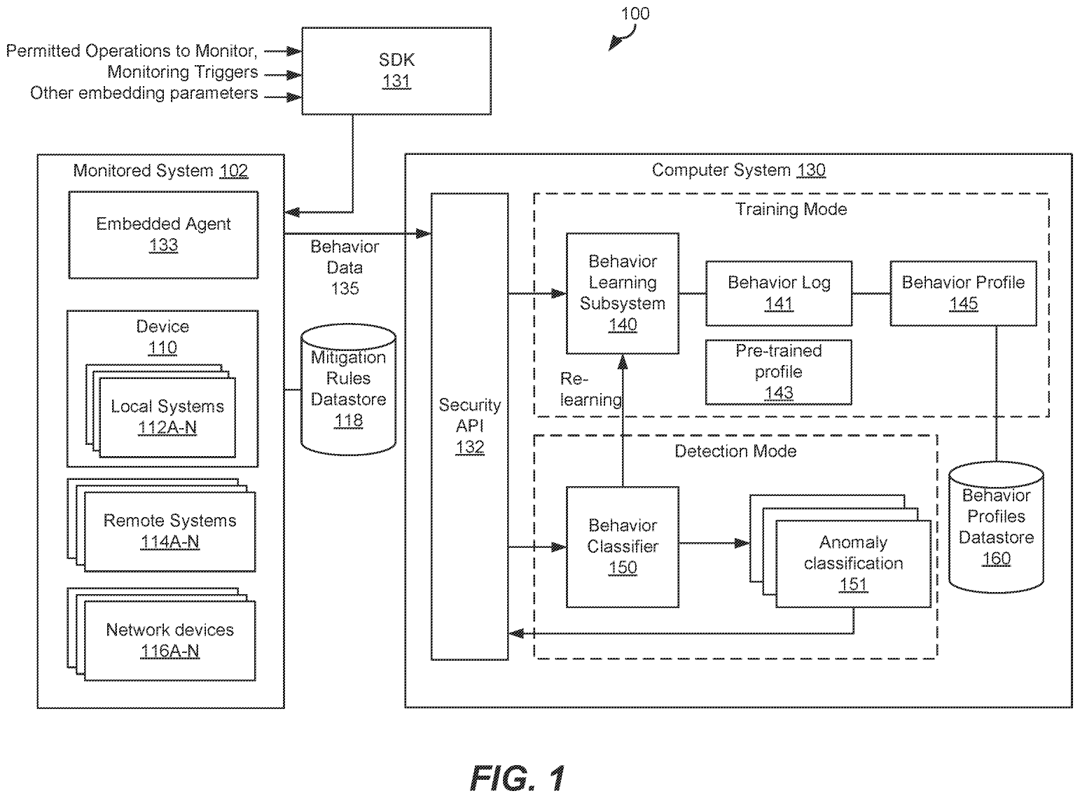

Having described a brief description of examples of the methods and systems described herein, attention will now turn to an example of a system environment for detecting anomalous computer activities. For example, FIG. 1 illustrates an example of a system environment 100 for detecting anomalies based on behavior modeling learned from monitored computer activities. The system environment 100 may include a monitored system 102, a computer system 130, and/or other features.

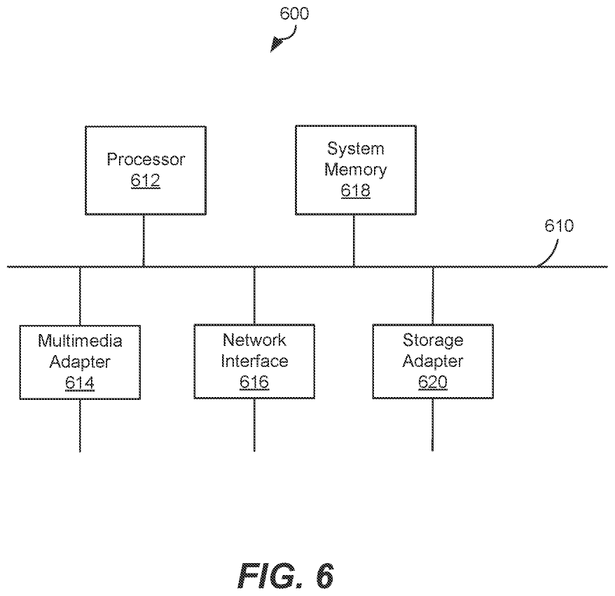

The monitored system 102 is a computer system at which one or more computer activities may be requested and/or executed. The monitored system 102 may include an embedded agent 133, a device 110, one or more remote systems 114A-N, one or more network devices 116A-N, a mitigation rules datastore 118, and/or other features. The computer system 130 is a system that generates an anomaly classification 151 of behavior data from the monitored system 102. The computer system 130 may include a Security Application Programming Interface (API) 132, a behavior learning subsystem 140, a behavior classifier 150, a behavior profile datastore 160, and/or other features. One or more of the foregoing features of the monitored system 102 and/or the computer system 130 may be implemented by some or all of the computer system illustrated in FIG. 6.

A computer activity may be executed at, or requested from, the device 110, a server device 114, a network device 116, and/or other component of the monitored system 102. A device 110 is a device operated by an end user to execute or request one or more computer activities. The device 110 may include one or more local systems 112, such as software, hardware, filesystems, and/or other types of systems that facilitate a computer activity. For example, a user may request to access a file stored at or accessed by a local system 112.

A server device 114 may include a device remote from the device 110 in the monitored system 102. The server device 114 may include a device with which the device 110 may communicate in the monitored system 102. In some instances, the device 110 may request a computer activity from the server device 114, such as a request to access a file stored or accessed by server device 114.

A network device 116 is a device that facilitates communication through a network, including local area networks (such as within a firewall of the monitored system 102) and wide area networks (such as outside the firewall). Examples of a network device 116 may include a hub, a switch, a router, a gateway, a repeater, a modem, and/or other device that facilitates communication over a network.

A mitigation rules datastore 118 may store mitigation rules that may be evaluated to determine a response to an anomaly classification 151 generated by the computer system 130. For example, the mitigation rules datastore 118 may store at least one mitigation rule for each anomaly class generated by the computer system 130. A mitigation rule is computational logic that defines a mitigation action to take in response to an anomaly classification 151. Examples of mitigation actions may include approving a request to execute a computer activity, denying the request, prompting for user authentication (and approving or denying the request subject to user authentication), relaying information that indicates the request to a mitigation contact such as an Information Technology (IT) administrator, and/or other types of actions to take.

One or more of the foregoing components of the monitored system 102 may be monitored by the embedded agent 133. In some examples, the embedded agent 133 may be developed using developer coding logic, such as a Software Development Kit (SDK) 131. The SDK 131 may be provided by an operator of the computer system 130 for developing an embedded agent 133. The SDK 131 may include documentation, software code, API calls to the Security API 132, examples of logic for the embedded agent 133, and/or other information that developers may use to develop and integrate an embedded agent 133 with the monitored system 102 so that the embedded agent 133 may interface with the computer system 130.

For example, the SDK 131 may include examples of embedded agent parameters that can be used to configure the behavior of the embedded agent 133. The embedded agent parameters may include a listing of computer activities that are permitted to be monitored, a monitoring trigger that defines when to transmit monitored computer activities, and/or other parameters that can be used to specify the behavior the of the embedded agent 133.

Table 1 illustrates examples of a permission configuration that specifies whether or not specific computer activities are permitted to be monitored.

| Computer Activity | Permitted? |
|---|---|
| Access files | Yes |
| Encrypt file | Yes |
| Delete file | Yes |
| Modify File | Yes |
| URL access | Yes |
| Other activities (. . .) | . . . |

One or more of the API calls may be configured to transmit data or instructions to the Security API 132. For example, an API call may be made to transmit behavior data 135 that indicates one or more computer activities requested via the monitored system 102. The behavior data 135 may include context data that is information indicating the circumstances or environment in which the one or more computer activities were requested. Context data may include a time, a date, a geolocation, a network location (such as an Internet Protocol (IP) address), a user account, a device identifier (such as MAC address), and/or other information associated with the monitored computer activities.

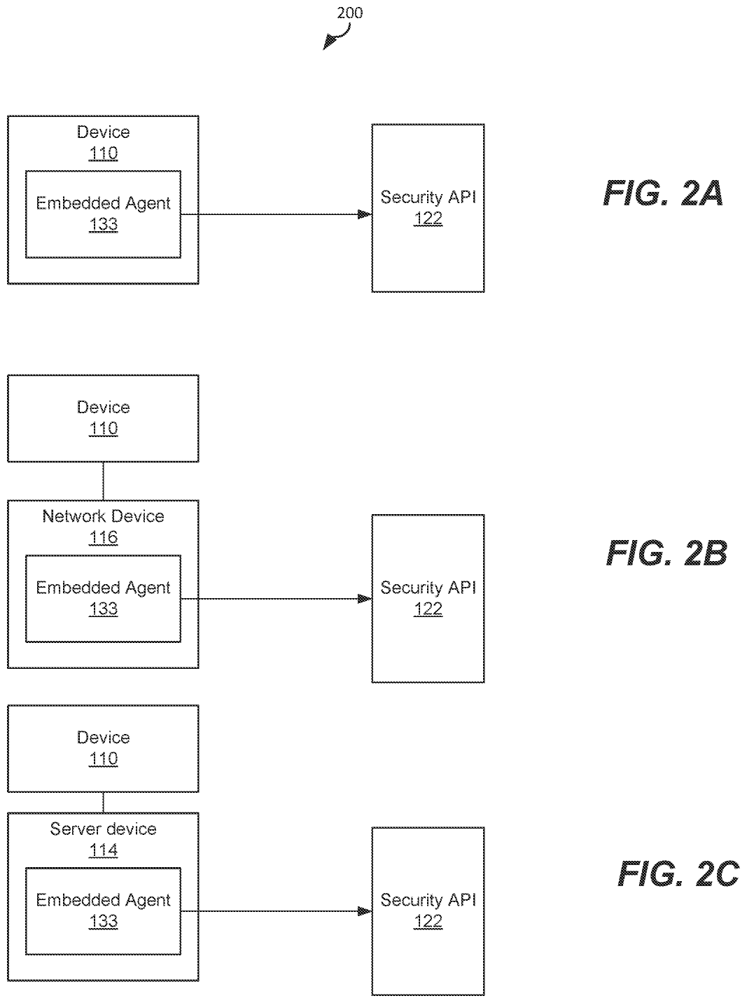

The embedded agent 133 may be integrated with the monitored system 102 in various ways, examples of which are illustrated in FIGS. 2A-2C. FIG. 2A illustrates the embedded agent 133 integrated with the device 110, which may be a user-operated device. In this example, the embedded agent 133 may be integrated with an operating system, a Virtual Private Network (VPN) application, and/or other software or hardware of the device 110. In this example, the embedded agent 133 may monitor computer activities requested and/or executed at the device 110. FIG. 2B illustrates the embedded agent 133 integrated with a server device 114. In this example, the embedded agent 133 may monitor computer activities or requests for computer activities that are routed to a server device 114 of the monitored system 102. FIG. 2C illustrates the embedded agent 133 integrated with a network device 116. In this example, the embedded agent 133 may monitor computer activities or requests for computer activities that are routed through a network, such as a network of the monitored system 102 and/or outside the monitored system 102. It should be noted that the embedded agent 133 may be integrated with one or more of the devices illustrated in FIGS. 2A-2C.

Referring back to FIG. 1, the monitored system 102 may transmit information that identifies a requested computer activity to the computer system 130. For example, the embedded agent 133 may detect that a user is attempting to access a particular file stored at the monitored system 102 (or a cloud-based storage coupled to the monitored system 102) and may transmit an indication of the request to the computer system 130 via an API call of the Security API 132. For example, the embedded agent 133 may generate behavior data 135.

In response, the computer system 130 may generate and return an anomaly classification 151 of the behavior data. The anomaly classification 151 may be a distinct anomaly class from among a multi-class classification. Each anomaly class corresponds to a level of anomalousness of the computer activity defined by the behavior data 135. For example, a first anomaly class may represent a lesser chance that the requested operation is abnormal than a second anomaly class. The number of anomaly classes may be predefined. In some examples, the anomaly classification may be continuous such that the anomaly classification is a quantitative value that estimates a level of anomalousness of the requested computer activity. In these examples, the quantitative value is a continuous value, such as within a range from 0 to 1. In particular, a first anomaly classification value may indicate may represent a lesser chance that the requested operation is abnormal than a second anomaly classification values. Whether multi-class or continuous, based on the anomaly classification 151, the monitored system 102 may take mitigative actions such as denying the computer activity, requiring user authentication before granting the computer activity, notifying an appropriate contact person, and/or other actions to prevent or mitigate against a harmful effects of the anomalous computer activity.

### Learning Computer Activity Behavior in Training Mode

Training mode may be initiated by the embedded agent 133 and/or by the computer system 120. For example, the embedded agent 133 may transmit behavior data 135 with a training mode indication. In this example, in response to an API call from the embedded agent 133 that transmits behavior data 135, the Security API 132 may forward the behavior data 135 to the behavior learning subsystem 140. In another example, the computer system 120 may initiate training mode such as when a behavior profile is unavailable for the requester or when the behavior profile has not been updated within a predefined length of time.

During training mode, the behavior learning subsystem 140 may learn expected computer activities of a requester based on the behavior data 135. For example, the behavior learning subsystem 140 may receive behavior data 135 from the embedded agent 133 and store the behavior data 135 in a behavior log 141, which is used to learn a behavior profile 145.

The behavior log 141 may include a requester identifier, one or more monitored computer activities, one or more values for the monitored computer activities, context data for the monitored computer activities, and/or other information from the behavior data 135. The behavior log 141 may store the computer activities of one or more requesters. An example of data stored in the behavior log 141 is illustrated in Table 2.

Table 2 illustrates examples of data stored in a behavior log 141 of a requester identified by the requester ID 1234. Each entry in the behavior log 141 may include one or more computer activities requested by the requester.

| | Monitored | | | |
|---|---|---|---|---|
| | Computer | Monitored | | |
| Requester ID | Activity | Value | Date/Time | IP Address |
| 1234 | Access files | 1 | MM:DD:YYYY | XXX.XXX.XXX.XX |
| | | | 12:02:45 PM | |
| 1234 | Access files | 5 | MM:DD:YYYY | XXX.XXX.XXX.XX |
| | | | 12:07:45 PM | |
| 1234 | Delete files | 1 | MM:DD:YYYY | XXX.XXX.XXX.XX |
| | | | 10:07:45 AM | |
| 1234 | . . . | | | |

The behavior learning subsystem 140 may generate a behavior profile 145 based on the behavior log 141. The behavior profile 145 is data that indicates a requester's expected computer activities, which may represent normal behavior of the requester. Computer activities that deviate from the behavior profile 145 may indicate anomalous behavior that may indicate requests that are not from the requester to which the behavior profile 145 relates. The behavior profile 145 may include an indication of one or more computer activities, monitored values for the computer activities, respective context data, context data weights, and/or other information learned about computer activities of a requester.

To learn from the behavior log 141, the behavior learning subsystem 140 may group monitored values by type of computer activity in the behavior log 141 and determine an aggregate value for each group. For example, the behavior learning subsystem 140 may group file accesses together and aggregate the number of times that the requester accessed files. In this example, the behavior learning subsystem 140 may learn that a requester ID “1234” accessed six files based on the behavior log 141. The behavior learning subsystem 140 may also maintain context data for each aggregated value. For example, the behavior learning subsystem 140 may learn context data that indicates that the requester ID “1234” accessed the six files from a single IP address and at certain times during the day.

Each of the context data may be assigned with a respective weight. A weight is a quantitative value that is used to adjust a value for a corresponding context. For example, a first context may be deemed to be more predictive of normal behavior than a second context. To illustrate, the time of day in which a computer activity occurs may be more predictive of normal activity than an IP address from which the computer activity was requested (or vice versa). In this example, the time of day context may be weighted more heavily than the IP address context. It should be noted that the first context data may be equal-weighted with respect to second context data, and other numbers of context data and their respective weights may be learned. Each of the weights may be initially predefined and then re-learned as new behavior data 135 is received. For example, one or more weights may be re-adjusted depending on the performance of the anomaly classifications 151, as will be discussed with respect to retraining. The weights may therefore be specific to a particular requester (the learned weights and/or other learned data may be learned specifically based on behavior data of the requester).

In some examples, the behavior learning subsystem 140 may bootstrap the behavior profile 145 using a pre-trained profile 143. The pre-trained profile 143 may include pre-trained values for one or more computer activities. Each pre-trained value may be predefined and used as a default value for a computer activity, a replacement value, or an aggregate value for a computer activity in the behavior profile 145. The pre-trained value may be used as a default value when there is no previous monitored activity for the requester. For example, if the requester did not request file encryption during the training phase, then a pre-trained value for number of file encryptions may be used as a threshold value.

Similarly, if there is an insufficient value of a monitored computer activity, the pre-trained value may be used as a replacement value that is used instead of the monitored value. For example, if a requester encrypted a file once during the training phase but a minimum of four or other predefined minimum number of observations has not been satisfied, then the pre-trained value for number of file encryptions may be used instead of the monitored value. The pre-trained value may be used as an aggregate value by averaging the pre-trained value and the monitored value in the event that the number of monitored values is below the predefined minimum number of observations. Whether the pre-trained value will be used as a default value, instead of a monitored value, or in addition to an existing monitored value may be configured by an operator of the monitored system 102 and/or the computer system 120.

In some examples, the pre-trained profile 143 may include default weights for one or more types of context data. The weights may be initially predefined and used as a default value, replacement value, or aggregate value similar to the pre-trained values for the computer activities. Each weight may be adjusted and retrained during a subsequent training mode and/or during detection mode.

In some examples, the behavior learning subsystem 140 may use transfer learning to generate the behavior profile 145. For example, the behavior learning subsystem 140 may apply some or all of the data in a first behavior profile 145 of a first requester to a second behavior profile 145 of a second requester. The first requester and the second requester may be deemed to share similarity to one another, such as having the same user role within an organization, providing a similar type of service, and/or having one or more other similarities. In particular, the learned threshold values, context data and corresponding weights, and/or other learned behavior data 135 may be transferred from the first behavior profile to the second behavior profile.

The behavior learning subsystem 140 may repeat the learning process for monitored values of each computer activity in the behavior log 141. The behavior learning subsystem 140 may use some or all of the records in the behavior log 141 to learn a behavior profile 145. For example, the behavior profile 145 may use the most recent N records, where N is an integer, the most recent records within a certain time frame, any time frame that is within the behavior log 141, and/or other portion or complete set of data in the behavior log 141.

In some examples, the behavior profile 145 may be requester-specific. The requester may be a user identified by a user identifier, a device identified by a device identifier, a service identified by a service identifier, a group of users, a group of devices, and/or other entity or process that can request one or more computer activities. In these examples, the behavior profile 145 may include learned behavior of a specific requester so that the behavior of that specific user may be classified. Likewise, the behaviors of a specific device or service may be learned. A behavior profile 145 may be specific to other things, such as groups of users. In this example, the behavior data 135 of a group of users sharing similar roles (such as IT user, sales, etc.) may be grouped together for learning a group-specific behavior profile.

### Anomaly Classification

During detection mode, the behavior classifier 150 may generate an anomaly classification 151 based on the behavior data 135 and the behavior profile 145. For each behavior data point in the behavior data 135, the behavior classifier 150 may determine a deviation of the behavior data point in the behavior data 135 from a corresponding data point in the behavior profile 145. For example, the behavior classifier 150 may compare each behavior data point with a corresponding data point in the behavior profile 145 to generate a vector value. A vector value is a quantitative, such as numeric, representation of a deviation of an observed behavior data point from an expected data point. In this example, the vector value may be a difference between an observed and an expected value for a behavior data point. Each vector value may be transformed to a sub-classification score. The transformation may normalize each of the sub-classification scores with respect to one another. For example, the transformation may use the same classifications that is used for the anomaly classifications 151. In this example, the sub-classification scores may range from 1-5, in which 5 represents the most anomalousness and therefore greatest deviation from the learned behavior profile 145. Each transformed vector value, or sub-classification score, may be weighted by a respective weight that has been pretrained and/or retrained for the behavior data point by the behavior learning subsystem 140. The behavior classifier 150 may aggregate the weighted sub-classification scores to generate the anomaly classification 151. For example, the anomaly classification 151 may be a weighted average of the sub-classification scores.

To generate a sub-classification score for the type of computer activity, the behavior classifier 150 may determine whether the observed type of computer activity in the behavior data 135 is seen in the behavior profile 145. For example, if the requester has not accessed files according to the behavior profile 145, then a binary value of 1 may be assigned. A binary value of 0 may be assigned if the requester has previously performed the computer activity. The binary value of 1 may be transformed to a sub-classification score of 5 to indicate that accessing files is abnormal for this requester. The binary value of 1 may be transformed to other sub-classifications from 2-4 as well. A binary value of 0 may indicate that the requester has accessed files in the past and therefore requesting this activity is not anomalous. As such, the behavior classifier 150 may transform a binary value of 0 to a sub-classification score of 1 to indicate low anomalousness for this type of activity. This sub-classification score may be weighted based on the weight assigned to the type of computer activity behavior data point.

To generate a sub-classification score for the computer activity value, the behavior classifier 150 may apply a transformation scale that defines sub-classification scores. For example, the behavior classifier 150 may determine that the requester has requested access to 400 files based on the behavior profile 145 and that the observed behavior data point is 1000. The behavior classifier 150 may apply the transformation scale based on the vector value. The transformation scale may be relative or absolute. A relative transformation scale may associate a sub-classification score with a relative proportion that is based on the observed and expected activity values. For example, the vector value of 600 is 1.5 times the expected value. Put another way, the observed value of 1000 file access requests is 2.5 times the expected value. In either instance, the transformation scale may associate higher (more anomalous) sub-classification scores based on higher vector values. To illustrate, a relative transformation scale may associate sub-classification scores as follows: a sub-classification score of 1 is associated with proportions 0-1.2. In this example, the proportion represents a ratio between the observed behavior data point and the expected data point. Also in this example, the sub-classification score 1 tolerates a certain deviation value to be considered normal. Thus, if the 400 file accesses is considered normal according to the behavior profile 145, then 0 to 480 (ratio 0 to 1.2) will be considered normal and assigned to a sub-classification score of 1. The transformation scale may associate remaining sub-classification scores to other ratios in a similar manner. A transformation scale that is absolute may similarly associate sub-classification scores based on vector values. Instead of proportions as in a transformation scale that is relative, a transformation scale that is absolute may specify absolute vector values. For instance, a sub-classification score of 1 may be associated with a number of file accesses that are less than or equal to 80 file accesses above an expected value. A sub-classification score of 2 may be associated with a number of file accesses that exceed an expected value by 81 but less than 300, and so on.

The transformation scale, whether relative or absolute, may be initially preconfigured by an operator of the monitored system 102 and/or the computer system 120. Thereafter, the behavior learning subsystem 140 may retrain at least some of the transformation scale based on observations of performance of the resulting anomaly classifications.

To generate a sub-classification score for the IP address context, the behavior classifier 150 may apply a similar transformation scale, but based on the number of IP addresses from which accesses were made. Alternatively, or additionally, if available, the vector value may be based on an estimated physical distance between an observed IP address and an IP address in the behavior profile 145, wherein increasing physical distances are associated with higher sub-classification scores in the transformation scale, whether relative or absolute. A context-based sub-classification score may be referred to herein throughout as a “contextual sub-classification score.”

To generate a sub-classification score for the time context, the behavior classifier 150 may apply a similar transformation scale, but based on deviation from an expected time or range of time of day. For example, the transformation scale may be based on a number of seconds, minutes, hours or other amount of time that deviates from an expected time of day. In another example, the sub-classification score may be based on a rate of file accesses or other behaviors and the transformation scale may associate different sub-classification scores with different rates of file accesses. For example, an observed file access rate of 1000 files per day may be compared to an expected file access rate of 200 files per day. The transformation scale may associate increasingly higher file access rates with a corresponding higher sub-classification scores.

The behavior classifier 150 may generate a sub-classification score for other types of behavior data points as well. Once generated, the behavior classifier 150 may weight each sub-classification score and generate a weighted average of the sub-classification scores to generate the anomaly classification 151. In this way, the anomaly classification 151 may be based on one or more of the type of computer activity, values for the computer activity, and context data associated with the computer activity.

The computer system 120 may be configured to generate anomaly classifications 151 based on various types of threat profiles. For example, a ransomware threat profile may be characterized by attempts to scan network folders that are typically not accessed by an impacted device or user account, sending emails to email accounts not typically emailed, accessing files, encrypting or moving files, deleting files, and/or other activities. The computer system 120 may be configured to detect these and other computer activities based on the ransomware threat profile.

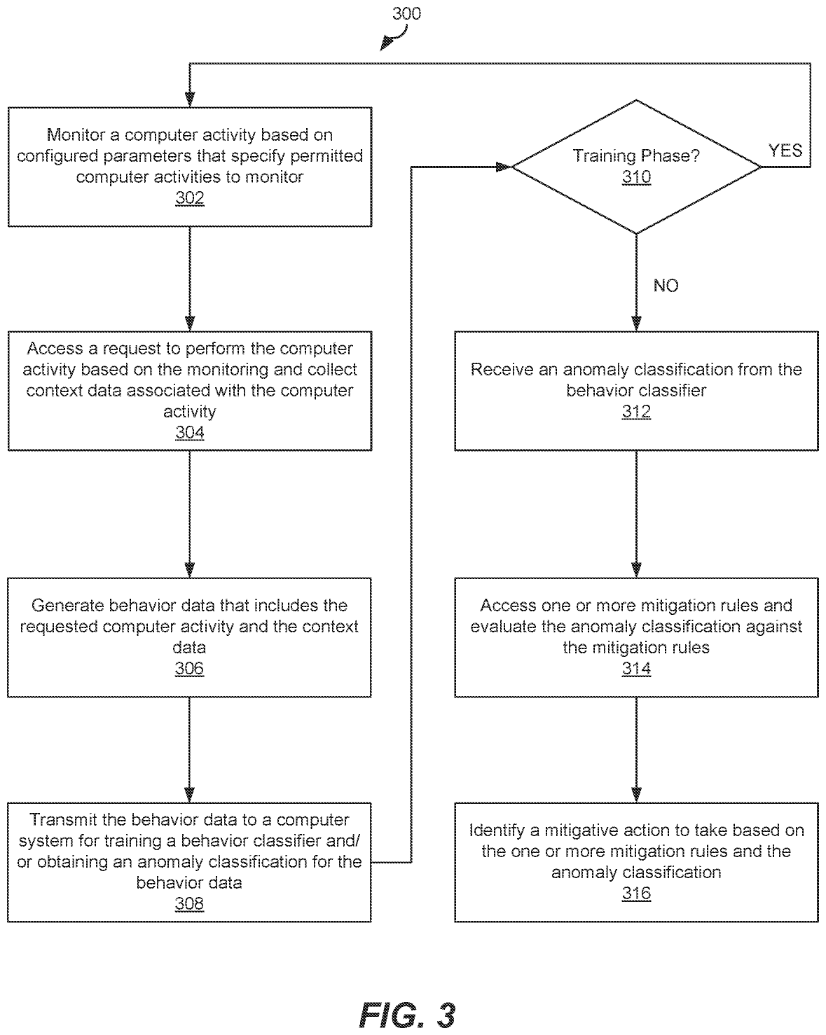

FIG. 3 illustrates an example of a method 300 of generating behavior data (such as behavior data 135) based on a monitored computer activity, transmitting the behavior data for generating an anomaly classification 151, and determining a mitigation action (if any) for the computer activity based on the anomaly classification 151.

At 302, the method 300 may include monitoring a computer activity based on configured parameters that specify one or more permitted computer activities to monitor. For example, an embedded agent 133 may be configured to monitor one or more computer activities that are permitted to be monitored, as specified in one or more embedding parameters.

At 304, the method 300 may include accessing a request to perform the computer activity based on the monitoring and collecting context data associated with the computer activity. The context data may include a time or date of the requested computer activity, an IP address associated with the request (such as an IP address from which the request was received or an IP address of a file or service requested), a geolocation associated with the request, and/or other information relating to the requested computer activity.

At 306, the method 300 may include generating behavior data based on the requested computer activity and any context data. For example, the behavior data may include a requester identifier that identifies the requester, an identification of the type of computer activity requested, a value for the type of computer activity requested (such as number of files), the context data, and/or other information relating to the computer activity.

At 308, the method 300 may include transmitting the behavior data to a computer system 120 for training a behavior classifier and/or for obtaining an anomaly classification for the behavior data. For example, the computer system may use the behavior data to train the behavior classifier during a training phase or to generate the anomaly classification during a detection phase. The computer system may further retrain, during the detection phase, the behavior classifier by updating the behavior profile based on the behavior data.

At 310, the method 300 may include determining whether the behavior data is used during the training phase. For example, the computer system may acknowledge receipt of the behavior data with an indication that the behavior data will be used for training. Alternatively, the method 300 may be configured to recognize that the training phase is initiated such as, for example, when the embedded agent 133 has been initially configured and/or when retraining is initiated. If training phase is initiated, the method 300 may return to 302, in which monitoring continues. Otherwise, if training phase is not on, then detection phase is initiated, in which case the method 300 may proceed to 312.

At 312, the method 300 may include receiving an anomaly classification from the behavior classifier. The anomaly classification may be a multi-class classification in which each anomaly class represents a level of anomalousness of the behavior data predicted by the behavior classifier.

At 314, the method 300 may include accessing one or more mitigation rules. In some examples, one or more mitigation rules may be stored in a mitigation rules datastore 118. Alternatively or additionally, one or more mitigation rules may be configured within the embedded agent 133. For example, a mitigation rule may be hardcoded within or otherwise parameterized in a library or configuration file for the embedded agent 133.

At 316, the method 300 may include identifying one or more mitigative actions to take based on the one or more mitigation rules and the anomaly classification. For example, one or more mitigation rules may each include an association between with a respective anomaly class and one or more actions to take. To illustrate, a first anomaly class indicating low anomalousness may be associated with no mitigative action to be taken and permission to execute the computer activity. A second anomaly class indicating elevated anomalousness compared to the first class may be associated with a mitigative action of generating an alert (such as to an IT administrator) and permission to execute the computer activity. A third anomaly class indicating elevated anomalousness compared to the second class may be associated with a mitigative action of requiring user authentication as a condition to execute the computer activity. Other classes may require progressively more aggressive mitigative actions, such as denying the computer activity to prevent malicious events from occurring.

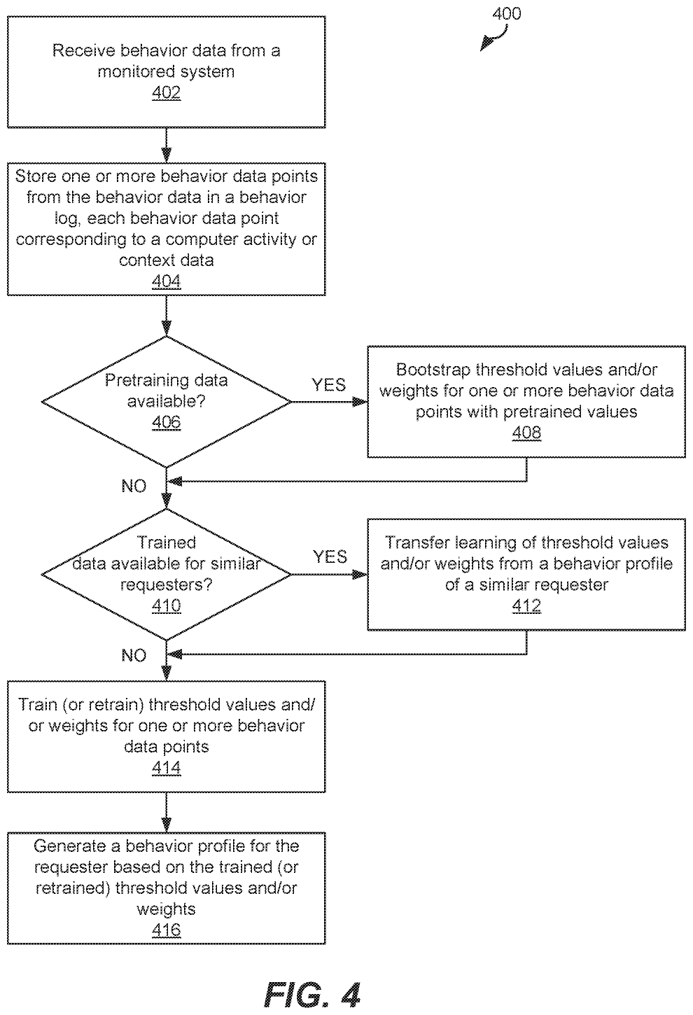

FIG. 4 illustrates an example of a method 400 of training a behavior classifier (such as behavior classifier 150) by learning behavior profiles (such as a behavior profile 145) based on monitored computer activities.

At 402, the method 400 may include receiving behavior data (such as behavior data 135) from a monitored system 102. The behavior data may be received from an embedded agent 133 that monitors computer activities of the monitored system 102.

At 404, the method 400 may include storing one or more behavior data points from the behavior data into a behavior log 141. Each behavior data point may correspond to a computer activity or context data for the computer activity. Thus, the behavior log 141 may include a log of computer activities requested by a requester at the monitored system 102 and context data for the requested computer activities.

At 406, the method 400 may include determining whether pretraining data is available. If so, at 408, the method 400 may include bootstrapping threshold values and/or weights for each behavior data point. Threshold values may include values or ranges of values that are associated with different levels of anomalousness. For example, a file access computer activity may have threshold value of 100 file accesses per day beyond which behavior data may be considered anomalous. Weights may be used to generated a weighted average of the behavior data points. Pretraining data may include predefined values and/or previously learned values.

At 410, the method 400 may include determining whether trained data is available for similar requesters. A similar requester is a requester that shares at least one similarity with the requester. Similarity between two requesters may be determined based on a shared role (such as both being members of a work group), similar office location or region of employment, and/or other metrics that may be used to determine whether two or more requesters are similar.

At 412, if trained data is available for a similar requester, the method 400 may include performing transfer learning of threshold values and/or weights based on the behavior profile of a similar requester. For example, one or more threshold values and/or one or more weights of the from the behavior profile of a similar requester may be used in the behavior profile 145 of the requester.

At 414, the method 400 may include training threshold values and/or weights for one or more behavior data points based on the behavior log 141. If bootstrap data and/or pretrained data is available, then 414 may include retraining the threshold values and/or weights based on the bootstrap and/or pretrained data. Retraining may include replacing, averaging, or other otherwise modifying the bootstrap data and/or pretrained data based on the behavior log 141. At 416, the method 400 may include generating a behavior profile 145 based on the trained (or retrained) threshold values and/or weights.

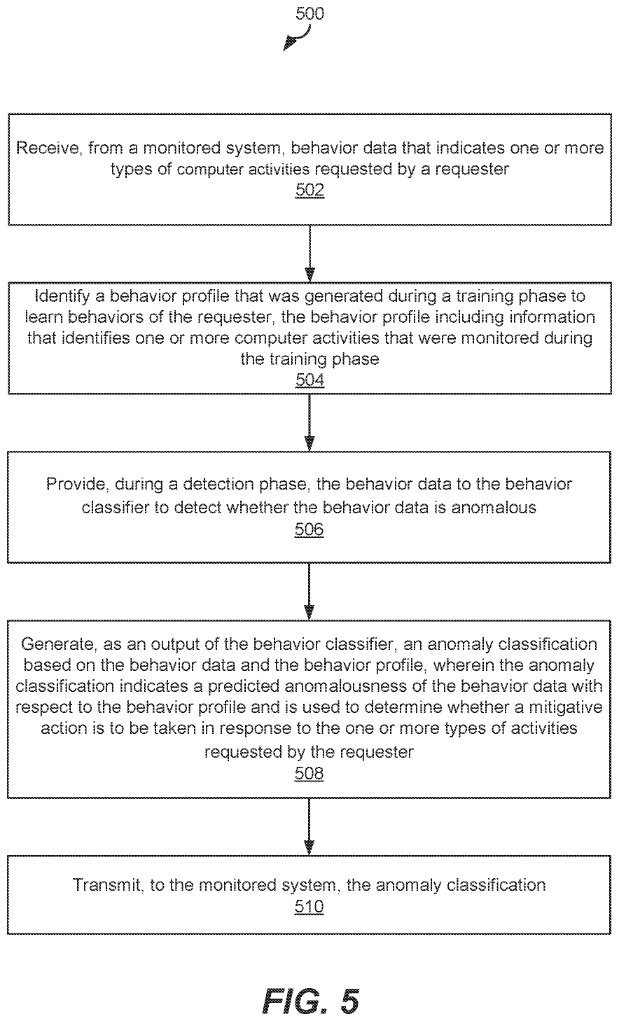

FIG. 5 illustrates an example of a method 500 of generating an anomaly classification 151 of behavior data 135 based on a previously learned behavior profile 145 used by a behavior classifier 150. At 502, the method 500 may include receiving, from a monitored system 102, behavior data 135 that indicates one or more types of computer activities requested by a requester. At 504, the method 500 may include identifying a behavior profile that was generated during a training phase to learn behaviors of the requester. The behavior profile may include information that identifies one or more computer activities that were monitored during the training phase.

At 506, the method 500 may include providing, during a detection phase, the behavior data 135 to the behavior classifier to detect whether the behavior data 135 is anomalous. At 508, the method 500 may include generating, as an output of the behavior classifier, an anomaly classification based on the behavior data 135 and the behavior profile, wherein the anomaly classification indicates a predicted anomalousness of the behavior data 135 with respect to the behavior profile and is used to determine whether a mitigative action is to be taken in response to the one or more types of activities requested by the requester. At 510, the method 500 may include transmitting, to the monitored system, the anomaly classification.

FIG. 6 illustrates an example of a computer system 600 that may implement the various features of FIGS. 1-5. The computer system 600 may be part of or include the system environment 100 to perform the functions and features described herein. For example, various ones of the devices of system environment 100 may be implemented based on some or all of the computer system 600.

The computer system 600 may include, among other things, an interconnect 610, a processor 612, a multimedia adapter 614, a network interface 616, a system memory 618, and a storage adapter 620. The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen). The network interface 616 may provide the computer system 600 with an ability to communicate with a variety of remove devices over a network. The network interface 616 may include, for example, an Ethernet adapter, a Fibre Channel adapter, and/or other wired- or wireless-enabled adapter. The network interface 616 may provide a direct or indirect connection from one network element to another, and facilitate communication and between various network elements. The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

The components of the system environment 100 illustrated in FIG. 1 may be connected to one another via a communication network (not illustrated), which may include the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The datastores described herein may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “130A, B, N” and 130A-N do not refer to three examples of 130, but rather “two or more.”

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a computer system comprising a processor programmed to:
receive, from a monitored system, behavior data that indicates one or more types of computer activities requested by a requester;
identify a behavior profile that was generated during a training phase to learn behaviors of the requester, the behavior profile including information that identifies one or more computer activities that were monitored during the training phase;
provide, during a detection phase, the behavior data to a behavior classifier to detect whether the behavior data is anomalous;
generate, as an output of the behavior classifier, an anomaly classification based on the behavior data and the behavior profile, wherein the anomaly classification indicates a predicted anomalousness of the behavior data with respect to the behavior profile and is used to determine whether a mitigative action is to be taken in response to the one or more types of activities requested by the requester; and
transmit, to the monitored system, the anomaly classification.

2. The system of claim 1, wherein to receive the behavior data, the processor is further programmed to:
receive the behavior data from an embedded agent of the computer system, the embedded agent operating at a device of the monitored system to monitor the one or more types of computer activities without modifying a process that provides the one or more computer activities.

3. The system of claim 2, further comprising:
a device of the monitored system, wherein the device is programmed via developer coding logic that encodes one or more monitoring parameters that each identifies a permitted type of computer activity that the embedded agent is permitted to monitor; and
cause, based on the developer coding logic, the embedded agent to monitor only the permitted type of computer activity specified by the one or more monitoring parameters.

4. The system of claim 2, further comprising:
a device of the monitored system, wherein the device is programmed with the embedded agent to:
identify the mitigative action based on the anomaly classification and one or more mitigation rules; and
execute the mitigative action responsive to a request to perform the one or more computer activities.

5. The system of claim 1, wherein to generate the anomaly classification, the processor is further programmed to:
determine a vector value based on a monitored value of a computer activity and an expected value of the computer activity from the behavior profile; and
transform the vector value to a sub-classification score, wherein the anomaly classification is based on the sub-classification score.

6. The system of claim 5, wherein the behavior data comprises context data that specifies a context in which the computer activity was requested, and wherein the processor is further programmed to:
determine a contextual vector value based on a monitored contextual value of the context data for the computer activity and an expected value of the context data from the behavior profile; and
transform the contextual vector value to a contextual sub-classification score, wherein the anomaly classification is further based on the contextual sub-classification score.

7. The system of claim of claim 6, wherein the context data comprises a time and/or date of the computer activity.

8. The system of claim of claim 6, wherein the context data comprises a rate of the computer activity over time.

9. The system of claim 6, and wherein to generate the anomaly classification, the processor is further programmed to:
apply a first weight to the sub-classification score and a second weight to the contextual sub-classification score, wherein the anomaly classification is based on the weighted sub-classification score and the weighted contextual sub-classification score.

10. The system of claim 9, wherein the first weight and/or the second weight are each initially predefined and then each updated based one retraining from new behavior data.

11. The system of claim 1, wherein the processor is further programmed to:
re-learn the behavior profile based on the behavior data and/or new behavior data.

12. A method, comprising:
receiving, by a processor of a computer system, from a monitored system, behavior data that indicates one or more types of computer activities requested by a requester;
identifying, by the processor, a behavior profile that was generated during a training phase to learn behaviors of the requester, the behavior profile including information that identifies one or more computer activities that were monitored during the training phase;
providing, by the processor, during a detection phase, the behavior data to a behavior classifier to detect whether the behavior data is anomalous;
generating, by the processor, as an output of the behavior classifier, an anomaly classification based on the behavior data and the behavior profile, wherein the anomaly classification indicates a predicted anomalousness of the behavior data with respect to the behavior profile and is used to determine whether a mitigative action is to be taken in response to the one or more types of activities requested by the requester; and
transmitting, by the processor, to the monitored system, the anomaly classification.

13. The method of claim 12, wherein receiving the behavior data comprises:
receiving the behavior data from an embedded agent of the computer system, the embedded agent operating at a device of the monitored system to monitor the one or more types of computer activities without modifying a process that provides the one or more computer activities.

15. The method of claim 12, further comprising:
identifying, by a device of the monitored system, the mitigative action based on the anomaly classification and one or more mitigation rules; and
executing, by the device, the mitigative action responsive to a request to perform the one or more computer activities.

16. The method of claim 12, wherein generating the anomaly classification comprises:
determining a vector value based on a monitored value of a computer activity and an expected value of the computer activity from the behavior profile; and
transforming the vector value to a sub-classification score, wherein the anomaly classification is based on the sub-classification score.

17. The method of claim 16, wherein the behavior data comprises context data that specifies a context in which the computer activity was requested, the method further comprising:
determining a contextual vector value based on a monitored contextual value of the context data for the computer activity and an expected value of the context data from the behavior profile; and
transform the contextual vector value to a contextual sub-classification score, wherein the anomaly classification is further based on the contextual sub-classification score.

18. The method of claim 17, wherein generating the anomaly classification comprises:
applying a first weight to the sub-classification score and a second weight to the contextual sub-classification score, wherein the anomaly classification is based on the weighted sub-classification score and the weighted contextual sub-classification score.

19. The method of claim 12, the method further comprising:
re-learning the behavior profile based on the behavior data and/or new behavior data.

20. A computer readable medium storing instructions of an embedded agent that, when executed by one or more processors, program the one or more processors to:
access a request by a requester to execute a computer activity;
obtain context data associated with the computer activity;
generate behavior data comprising an identification of the computer activity and the context data;
transmit the behavior data to a computer system for anomaly classification of the behavior data;
receive an anomaly classification from the computer system, the anomaly classification representing a prediction of an extent to which the computer activity deviates from a learned normal behavior based on previously learned computer activities of the requester;
access one or more mitigation rules corresponding to the anomaly classification; and
identify a mitigative action to take or no mitigative action to take based on the one or more mitigation rules.
